(19) United States
(12) Patent Application Publication
(10) Pub. No.: US 2009/0160794 A1
(43) Pub. Date: Jun. 25, 2009

(54) Method for Scroll Control on Window by a Touch Panel

(76) Inventors: Chia-Yi Lee, Hsin-Chu City (TW); Yen-Chen Chiu, Hsin-Chu City (TW)

Correspondence Address: HDLS Patent & Trademark Services, P.O. BOX 220746, CHANTILLY, VA, 20153-0746, US

(21) Appl. No.: 12/270,927

(22) Filed: Nov. 14, 2008

(30) Foreign Application Priority Data
Dec. 21, 2007 (TW) 096149485

(51) Int. Cl. G06F 3/041

(52) U.S. Cl. 345/173

(57) ABSTRACT

A method for scroll control on a window by a touch panel includes detecting the number of objects touching on the touch panel, enabling a scrolling function when the number of the objects is a first predetermined number, and detecting whether at least one of the objects is touching on an edge of the touch panel after the scrolling function is enabled, if at least one of the objects is touching on the edge of the touch panel, automatically performing a corresponding one of a vertical scrolling and a horizontal scrolling toward a positional direction of the edge. The method is more conveniently operative to the user.

### BACKGROUND

1. Technical Field

The present invention generally relates to a method for performing scrolling function and, particularly, to a method for scroll control on a window by a touch panel.

2. Description of the Related Art

Nowadays, since the advantages of simple, lightweight and low price, touch panels are widely used in various types of electronic products to replace traditional input peripheral devices such as computer mice. U.S. Pat. No. 5,943,052 has proposed an apparatus and a method for scroll bar control, wherein a scroll zone is defined on a touch panel for scroll control, the disclosure of which is fully incorporated herein by reference. As illustrated in FIG. 1, the touch panel 10 includes a plurality of defined zones 12, 14 and 16, the zone 12 is a mouse pointer operation zone, the zone 14 is a vertical scrolling zone and the zone 16 is a horizontal scrolling zone. When a user wants to move a mouse pointer, the user's finger is required to run on the mouse pointer operation zone 12. When the user wants to perform a vertical scrolling, an object is required to run on the vertical scrolling zone 14 and the scrolling is performed according to a vertical movement distance of the object. Likewise, when the user wants to perform a horizontal scrolling, the object is required to run on the horizontal scrolling zone 16 and the scrolling is performed according to a horizontal movement distance of the object.

However, if the user wants to perform both the vertical scrolling and the horizontal scrolling, it is necessary to define both the vertical scrolling zone 14 and the horizontal scrolling zone 16, but the definition of the vertical scrolling zone 14 and the horizontal scrolling zone 16 would inevitably result in the mouse pointer operation zone 12 becomes smaller. Furthermore, the vertical scrolling zone 14 and the horizontal scrolling zone 16 only can be activated one of them each time rather than both of them at the same time. In addition, when performing functions switching in every time, for example switching the mouse pointer operation function to the scrolling function, in order to enable the scrolling function, it is necessary to firstly make the object to exit the touch panel 10 and then run the object on the vertical scrolling zone 14 or the horizontal scrolling zone 16. Whereas, if directly moving the object from the mouse pointer operation zone 12 into the vertical scrolling zone 14 or the horizontal scrolling zone 16, the vertical scrolling zone 14 or the horizontal scrolling zone 16 can not be activated, which causes inconvenience for the user. Furthermore, when performing scrolling, the object is required to keep moving; if the scrolling time is excessive long, which would cause the object tired and fatigued easily.

Therefore, what is needed is a method for scroll control on a window by a touch panel, which is more conveniently operative to the user.

### BRIEF SUMMARY

A method for scroll control on a window by a touch panel, in accordance with an embodiment of the present invention, is provided. The method includes the steps of: detecting the number of objects touching on the touch panel; enabling a scrolling function when the number of the objects is a first predetermined number; and detecting whether at least one of the objects is touching on an edge of the touch panel after the scrolling function is enabled, if at least one of the objects is touching on the edge of the touch panel, automatically performing a corresponding one of a vertical scrolling and a horizontal scrolling toward a positional direction of the edge.

In one embodiment, when detecting whether at least one of the objects is touching on the edge of the touch panel, if none of the objects is touching on the edge of the touch panel, calculating a movement distance of the objects moving on the touch panel and using the movement distance as a basis for scrolling speeds of the vertical scrolling and the horizontal scrolling.

Compared with the prior art, the method of scroll control on a window by a touch panel in accordance with the present invention determines whether to enable the scrolling function by detecting the number of the objects and thus is more conveniently operative. Furthermore, after an automatic scrolling function is enabled (when at least one of the objects is touching on the edge of the touch panel), an automatic scrolling in the movement direction of the objects can be performed by moving the objects only one time and thereby the objects are not needed to keep moving, so that the objects do not become tired and fatigue easily.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a touch panel in accordance with the prior art.

FIG. 2 is a schematic view of a touch panel, in accordance with an embodiment of the present invention.

FIG. 3 is a flow chart of a method for scroll control on a window by the touch panel of FIG. 2.

FIG. 3A shows an edge of the touch panel of FIG. 2.

FIG. 4 illustrates movement directions of objects touching on the touch panel of FIG. 2.

FIG. 5 illustrates another movement direction of the objects touching on the touch panel of FIG. 2.

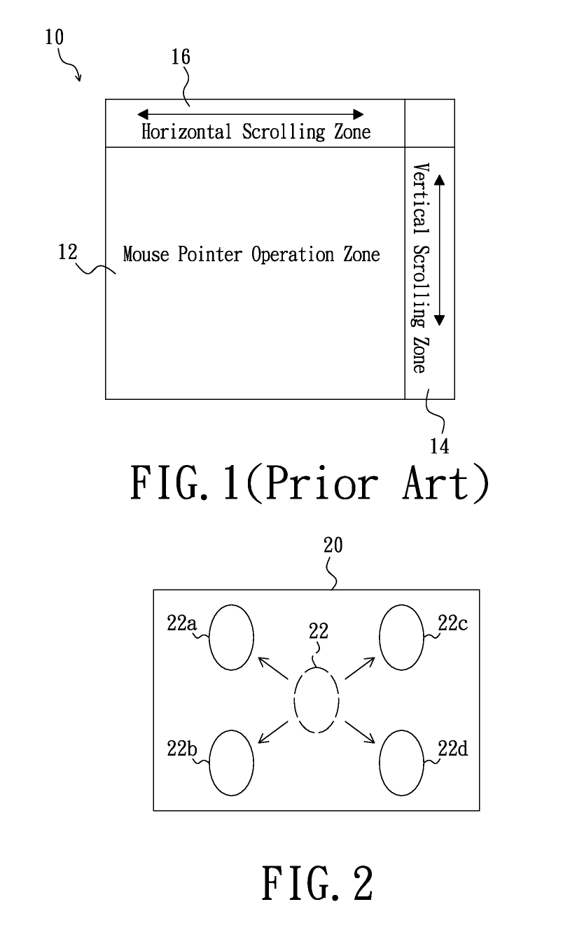

### DETAILED DESCRIPTION

FIG. 2 illustrates performing a mouse pointer operation on a touch panel 20 by an object (not shown). The touch panel 20 serves as an input device for a system and the object can arbitrarily move on the touch panel 20 to control the movement of a mouse pointer. For example, the object can move from a touch position 22 to another touch position 22a to cause the mouse pointer to move toward the top-left of the touch panel 20, can move from the touch position 22 to another touch position 22b to cause the mouse pointer to move toward the down-left of the touch panel 20, can move from the touch position 22 to another touch position 22c to cause the mouse pointer to move toward the down-right of the touch panel 20, or can move from the touch position 22 to another touch position 22d to cause the mouse pointer to move toward the top-right of the touch panel 20.

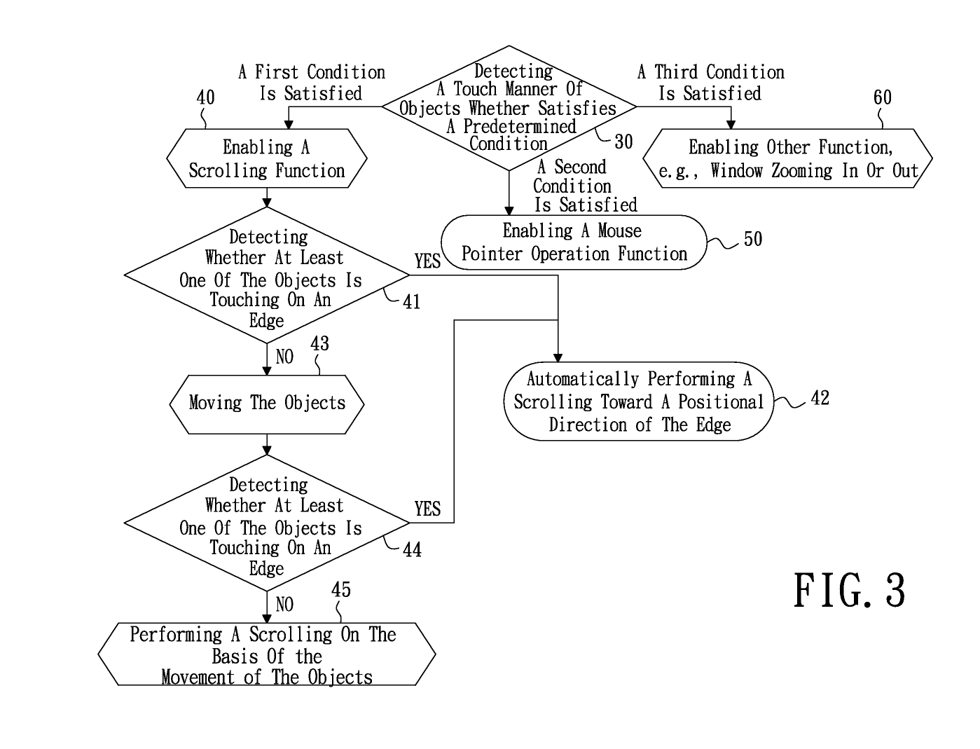

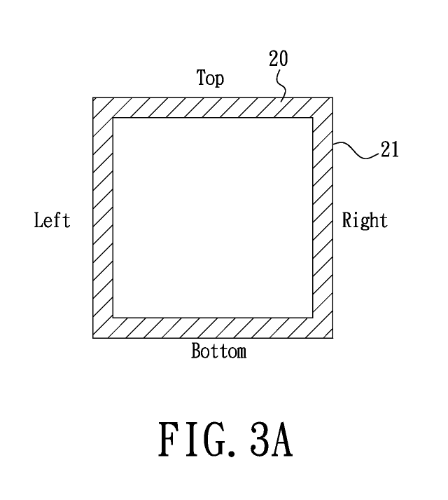

FIG. 3 is a flow chart of a method for scroll control on a window by the touch panel 20, in accordance with an embodiment of the present invention. Firstly, in step 30, detecting a touch manner of the objects on the touch panel 20 whether satisfies a predetermined condition. If a first condition is satisfied, e.g., the number of the objects is a first predetermined number (e.g., 2), goes to step 40 for enabling a scrolling function. If a second condition is satisfied, e.g., the number of the objects is a second predetermined number (e.g., 1), goes to step 50 for enabling a mouse pointer operation function. If a third condition is satisfied, e.g., the number of the objects is a third predetermined number (e.g., 3), at least one of the objects moves into a special zone or the touch manner of the objects is a specific manner, goes to step 60 for enabling other function, e.g., window zooming in or out.

After the scrolling function is enabled, goes to step 41 for detecting whether at least one of the objects is touching on an edge of the touch panel 20. If the detecting result is YES, go toes step 42 for enabling an automatic scrolling function and automatically performing a corresponding one of a vertical scrolling and a horizontal scrolling toward a positional direction of the edge 21. If the detecting result is NO, i.e., none of the objects is touching on the edge 21 of the touch panel 20, goes to step 43. More specifically, referring to FIG. 3A, a peripheral region of the touch panel 20 filled by oblique lines is defined as the above-mentioned edge 21. The edge 21 can be further demarcated into different edge segments according to positional directions (e.g., top, down, left and right) thereof. Once at least one of the objects is touching on the edge 21 after the scrolling function is enabled, the image displayed in the window automatically scrolls toward a positional direction of the edge 21 where the at least one of the objects is touching.

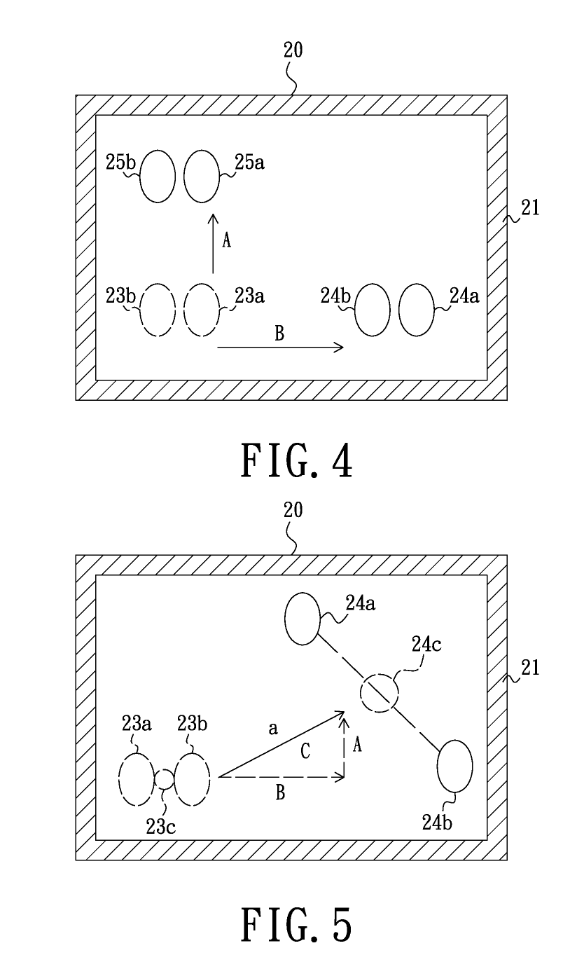

It is indicated that the expression of “at least one of the objects is touching on the edge 21” includes but not limited to the following situations: (1) one object touches the edge 21 or moves into the edge 21, (2) two or more objects touch the edges 21 or move into the edge 21, and (3) a middle point of a line connecting two objects touches the edge 21 or moves into the edge 21. In step 43, the user moves the objects on the touch panel 20 in a vertical direction or a horizontal direction. As illustrated in FIG. 4, when two objects start to move from initial touch positions 23a and 23b and only perform a vertical or horizontal movement, a vertical movement distance A (e.g., move to touch positions 25a and 25b) or a horizontal movement distance B (e.g., move to touch positions 24a and 24b) can be generated. Subsequently, goes to step 44.

In step 44, detecting whether at least one of the objects is touching on the edge 21 of the touch panel 20. If the detecting result is YES, goes to step 42 for automatically performing the vertical scrolling or the horizontal scrolling (i.e., a corresponding one of the vertical scrolling and the horizontal scrolling) toward a positional direction of the edge 21, i.e., for enabling an automatic scrolling. For example, if the at least one of the objects moves to the top of the edge 21, performing a vertical scrolling toward the top of the edge 21; if the at least one of the objects moves to the right of the edge 21, performing a horizontal scrolling toward the right of the edge 21. Whereas, if none of the objects is touching on the edge 21 of the touch panel 20 (i.e., the detecting result is NO), goes to step 45 for obtaining the value and direction of a vertical movement distance A or a horizontal movement distance B and transmitting a corresponding data to the system to let the system determine an automatic scrolling speed of the vertical scrolling or the horizontal scrolling according to the obtained result. In other words, the vertical scrolling or the horizontal scrolling is performed on the basis of the movement of the objects.

In another embodiment, when none of the objects is touching on the edge 21, besides the speed of the automatic scrolling (e.g., vertical scrolling or horizontal scrolling) can be determined according to the movement distance of the objects, a scrolling distance can be determined according to the movement distance of the objects similar to that of the prior art. In other words, when none of the objects is touching on the edge of the touch panel, each time movement of the objects only causes scrolling one time rather than continuous automatic scrolling.

The objects can move in other direction of a, besides the vertical and horizontal directions. As illustrated FIG. 5, when the objects move in a direction different from the vertical and horizontal directions, there are various approaches to determine the scrolling direction and the scrolling distance of the image displayed in the window, two exemplary approaches will be described in detail as follows.

A first approach is that: when two objects respectively move from initial touch positions 23a and 23b to touch positions 24a and 24b, a middle point of a line connecting the two objects moves from a position 23c along the direction of a to a position 24c correspondingly after moving a distance C. Based upon some simple calculations, a vertical movement distance component A and a horizontal movement distance component B of the middle point of the line connecting the two objects can be easily worked out. The vertical movement distance component A and the horizontal movement distance component B, or data corresponding to the vertical movement distance component A and the horizontal movement distance component B are transmitted to the system, so as to let the system control the scrolling status (or automatic scrolling speeds) of the vertical scrolling and the horizontal scrolling, so that the image displayed in the window can scroll along the above-mentioned direction of a. At this circumstance, both the vertical scrolling and the horizontal scrolling are performed.

A second approach is that: firstly obtaining the vertical movement distance component A and the horizontal movement distance component B of the middle point of the line connecting the two objects moving from the position 23c to the position 24c along the direction of a. If the difference value of the vertical movement distance component A subtracting the horizontal movement distance component B is larger than a reference value, transmitting a corresponding data to the system to control the vertical scrolling. If the difference value of the horizontal movement distance component B subtracting the vertical movement distance component A is larger than the reference value, transmitting a corresponding data to the system to control the horizontal scrolling.

When performing the automatic scrolling, a speed of automatic scrolling can be directly proportional to the movement speed of the objects, or a fixed speed can be set (e.g., the speed of automatic scrolling determined by the movement distance of the objects, as above-mentioned). During the period of automatic scrolling, if the objects touching on the edge 21 exit the edge 21 or the objects stop moving and start to move again after a period of time, closing the automatic scrolling function.

When the number of the objects is the third predetermined number, at least one of the objects moves into the special zone or the touch manner of the objects is the special manner, control flows to step 60 and enabling the window zooming in or out function, etc. After the function is enabled, the user can vertically or horizontally move the objects on the touch panel 20. As illustrated in FIG. 4, when the objects are vertically or horizontally moved, a vertical movement distance A or a horizontal movement distance B is generated correspondingly. By obtaining the value of the vertical movement distance A or the horizontal movement distance B, a corresponding data can be transmitted to the system to determine a variation used for the function. For example, after the window zooming in or out function is enabled, the variation for the window zooming in or out can be determined by using the value of the vertical movement distance A or the horizontal movement distance B.

In summary, the method for scroll control on a window by a touch panel in accordance with the present invention enables the scrolling function, the mouse pointer operation function and other functions by detecting the number of the objects and the touch manner of the objects, etc., and thus is more conveniently operative. Furthermore, after an automatic scrolling function is enabled, an automatic scrolling in the movement direction of the objects can be preformed by moving the objects only one time and thereby the objects are not needed to keep moving, so that the objects do not become tired and fatigue easily

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for scrolling scroll on a window by a touch panel, comprising:
detecting a number of objects touching on the touch panel;
enabling a scrolling function when the number of the objects is a first predetermined number; and
detecting whether at least one of the objects is touching on an edge of the touch panel, if at least one of the objects is touching on the edge of the touch panel, automatically performing a corresponding one of a vertical scrolling and a horizontal scrolling toward a positional direction of the edge.

2. The method according to claim 1, wherein when the number of the objects is a second predetermined number, enabling a mouse pointer operation function.

3. The method according to claim 1, wherein when detecting whether at least one of the objects is touching on the edge of the touch panel after the scrolling function is enabled, if none of the objects is touching on the edge of the touch panel, controlling a corresponding one of the vertical scrolling and the horizontal scrolling according to a movement distance of the objects.

4. The method of claim 3, wherein the step of controlling the corresponding one of the vertical scrolling and the horizontal scrolling according to the movement distance of the objects comprises:
obtaining a vertical movement distance component and a horizontal movement distance component of the objects; and
enabling an image displayed in the window to move in a movement direction of the objects, according to the vertical movement distance component and the horizontal movement distance component of the objects and scrolling speeds of the vertical scrolling and the horizontal scrolling.

5. The method of claim 4, wherein the scrolling speeds of the horizontal scrolling and the vertical scrolling are fixed.

6. The method of claim 4, wherein the scrolling speeds of the horizontal scrolling and the vertical scrolling are directly proportional to the movement distance of the objects.

7. The method of claim 3, wherein the step of controlling the corresponding one of the vertical scrolling and the horizontal scrolling comprises:
obtaining a vertical movement distance component and a horizontal movement distance component of the objects;
performing the vertical scrolling when a different value of the vertical movement distance component subtracting the horizontal movement distance component is larger than a reference value; and
performing the horizontal scrolling when a difference value of the horizontal movement distance component subtracting the vertical movement distance component is larger than the reference value.

8. The method of claim 7, wherein scrolling speeds of the horizontal scrolling and the vertical scrolling are fixed.

9. The method of claim 7, wherein scrolling speeds of the horizontal scrolling and the vertical scrolling are directly proportional to the movement distance of the objects.

10. The method of claim 1, further comprising:
enabling a predetermined function, when one of the circumstances of the number of the objects being a third predetermined number, at least one of the objects moving into a special zone and a touch manner of the objects being a special manner is detected.

11. The method of claim 10, wherein the predetermined function comprises window zooming in or out.
